(19) United States
(12) Patent Application Publication
(10) Pub. No.: US 2013/0179917 A1
(43) Pub. Date: Jul. 11, 2013

(54) Multi-Component Advertising Campaigns

(71) Applicants: Lei Gu, Chelmsford, MA (US); Aseem Bakshi, Stamford, CT (US)

(72) Inventors: Lei Gu, Chelmsford, MA (US); Aseem Bakshi, Stamford, CT (US)

(73) Assignee: SEACHANGE INTERNATIONAL, INC., Acton, MA (US)

(21) Appl. No.: 13/475,106

(22) Filed: May 18, 2012

Related U.S. Application Data
(60) Provisional application No. 61/584,726, filed on Jan. 9, 2012.

(51) Int. Cl. G06Q 30/02; H04N 21/80

(52) U.S. Cl. 725/32; 705/14.72

(57) ABSTRACT

A computerized method, system and computer program product for implementing a multi-component advertising campaign, respectively comprising steps, structure and instructions for defining data representing a multi-component advertising campaign, the data specifying one or more campaign instructions, each of the campaign instructions identifying a multi-component advertisement and targeted digital media having a plurality of advertising opportunities, each advertising component of the multi-component advertisement corresponding to a respective one of the plurality of advertising opportunities; receiving an advertising request from a requesting device during presentation of the targeted digital media; selecting one of the campaign instructions from the multi-component advertising campaign corresponding to the targeted digital media; and transmitting information for inserting the multi-component advertisement identified in the selected campaign instruction into the plurality of advertising opportunities of the targeted digital media.

### RELATED APPLICATIONS

This application claims the benefit of the filing date of U.S. Provisional Application No. 61/584,726, filed on Jan. 9, 2012, the entire contents of which are incorporated by reference in their entirety.

### TECHNICAL FIELD

Embodiments of the present invention generally relate to systems and methods for generating an advertising campaign, and more particularly, to systems, methods and computer readable program products for implementing multi-component advertising campaigns.

### BACKGROUND

With the advent of the Internet, brand managers and advertisers have adopted various types of online advertising mediums to inform, encourage and persuade their respective audience members. These advertising mediums include, for example, contextual ads, banner ads, interactive ads, audio ads, video ads and the like. The advertisements or “ads” can be incorporated into various forms of digital media, such as, internet websites, broadcast video streams and video-on-demand (VOD) streams.

In one example, the Google Adwords product by Google Inc. of Mountain View, Calif., is an auction based product that offers placement services for site-targeted text, banner, and rich-media ads. Placement targeting lets advertisers choose placements within the Google network. For example, advertisers can create an advertising campaign that displays ads on only the business pages of a newspaper websites. Although auction based products, such as the Google Adwords product, allows advertisers to target individual placements within an advertising network, these types of auction based products do not allow advertisers to create advertising campaigns that target all ad spots or placements (generally “advertising opportunities”) on a particular website or page of a website accessed by a given user.

In another example, the ad-supported VOD service by Hulu of Los Angles, Calif., offers placement services for instream video ads, branded slates and other visual ad experiences. For example, advertisers can purchase standard instream video ad spots. The instream video ad may appear as a commercial break during shows, a pre-roll or post-roll. Similar to the auction based products, ad-supported VOD services, such as Hulu's VOD service, do not allow advertisers to create advertising campaigns that target all ad spots or placements (generally “advertising opportunities”) within a particular media stream accessed by a given user.

### SUMMARY

Embodiments of the present invention are directed in part to systems, methods and computer readable program products for generating and implementing multi-component advertising campaigns for various forms of digital media, such as, internet websites, broadcast video streams and VOD streams. The systems and methods allow advertisers to create multi-component advertising campaigns that target all ad spots or placements on a particular website or page of a website accessed by a given user. The systems and methods also allow advertisers to create multi-component advertising campaigns that target all ad spots or placements within a particular media stream of a VOD service accessed by a given user. The systems and methods also allow advertisers to create multi-component advertising campaigns that target all ad spots or placements within a particular broadcast media stream accessed by a given user. In this manner, multi-component advertising campaigns allow advertisers to control all ad spots or placements within a content medium accessed by a user, and, in some embodiments, define ad spots or placements within the content medium accessed by the user.

Each advertising campaign includes a plurality of advertising components, which can be selected or defined by the advertiser. In some embodiments, the advertising components can be defined by the selected placement. For example a particular website can include a selected number and type of advertising components. Website placements can include pre-defined and definable advertising components of various types, such as, text ads, banner ads, floating ads, expanding ads, wallpaper ads, pop-up ads, video ads, audio ads, or other known ad types. VOD service placements can include various types of pre-defined and definable advertising components, such as, instream ads, pre-roll ads, post-role ads, banner ads, action bar ads, native ads or other known ad types.

The advertisers can also define targeting rules for associating a multi-component advertising campaign with a particular type of user or audience. The targeting rules can be based on user information such as, demographic data, geographic data or other user accessible data, and/or content metadata, such as, genre, rating or other accessible data. In this manner, a multi-component advertising campaign can target a user or audience based on, for example, user or audience information and content metadata.

Unlike conventional auction based products and ad-supported VOD services that provide fragmented advertising ad spots and placements, the systems and methods described herein can provide an integrated advertising campaign for a targeted user or audience of digital media. In this manner, advertisers can create and define a complete ad experience for users or audience members.

Aspects of the claimed invention include a computerized method for implementing a multi-component advertising campaign that comprises defining data representing a multi-component advertising campaign, the data specifying one or more campaign instructions, each of the campaign instructions identifying a multi-component advertisement and targeted digital media having a plurality of advertising opportunities, each advertising component of the multi-component advertisement corresponding to a respective one of the plurality of advertising opportunities; receiving an advertising request from a requesting device during presentation of the targeted digital media; selecting one of the campaign instructions from the multi-component advertising campaign corresponding to the targeted digital media; and transmitting information for inserting the multi-component advertisement identified in the selected campaign instruction into the plurality of advertising opportunities of the targeted digital media.

In particular embodiments, the computerized method can further comprise defining data representing a multi-component advertising campaign for a targeted web site, the data specifying one or more campaign instructions, each of the campaign instructions identifying a multi-component advertisement and a targeted web page of the web site, each advertising component of the multi-component advertisement corresponding to a respective one of the plurality of advertising opportunities in the targeted web page; receiving an advertising request from the requesting device identifying the targeted web page; and selecting one of the campaign instructions from the multi-component advertising campaign corresponding to the targeted web page; and transmitting instructions for inserting the multi-component advertisement identified in the selected campaign instruction into the plurality of advertising opportunities of the targeted web page.

In particular embodiments, the computerized method can further comprise defining data representing a multi-component advertising campaign for a targeted video stream, the data specifying one or more campaign instructions, each of the campaign instructions identifying a multi-component advertisement and the targeted video stream, each advertising component of the multi-component advertisement corresponding to a respective one of the plurality of advertising opportunities in the targeted video stream; receiving an advertising request from the requesting device identifying the targeted video stream; selecting one of the campaign instructions from the multi-component advertising campaign corresponding to the targeted video stream; and transmitting instructions for inserting the multi-component advertisement identified in the selected campaign instruction into the plurality of advertising opportunities of the targeted video stream.

In still particular embodiments, wherein each of the plurality of advertising opportunities is a time slot in the targeted video stream, the computerized method further comprises receiving a plurality of advertising requests from the requesting device during a presentation of the targeted video stream, each of the advertising requests identifying the targeted video stream and a time slot in the targeted video stream; selecting one of the campaign instructions from the multi-component advertising campaign corresponding to the targeted video stream; and in response to each of the advertising requests, transmitting instructions for inserting one of the constituent advertising components of the multi-component advertisement identified in the selected campaign instruction according to the time slot identified in the advertising request.

Another aspect of the claim invention is a system for implementing a multi-component advertising campaign, that comprises an advertisement decision management computing system configured to define data representing a multi-component advertising campaign, the data specifying one or more campaign instructions, each of the campaign instructions identifying a multi-component advertisement and targeted digital media having a plurality of advertising opportunities, each advertising component of the multi-component advertisement corresponding to a respective one of the plurality of advertising opportunities; the advertisement decision management computing system further configured to receive an advertising request from a requesting device during presentation of the targeted digital media; the advertisement decision management computing system further configured to select one of the campaign instructions from the multi-component advertising campaign corresponding to the targeted digital media; and the advertisement decision management computing system further configured to transmit information for inserting the multi-component advertisement identified in the selected campaign instruction into the plurality of advertising opportunities of the targeted digital media.

In particular embodiments, the computerized system further comprises the advertisement decision management computing system further configured to define data representing a multi-component advertising campaign for a targeted web site, the data specifying one or more campaign instructions, each of the campaign instructions identifying a multi-component advertisement and a targeted web page of the web site, each advertising component of the multi-component advertisement corresponding to a respective one of the plurality of advertising opportunities in the targeted web page; the advertisement decision management computing system further configured to receive an advertising request from the requesting device identifying the targeted web page; and the advertisement decision management computing system further configured to select one of the campaign instructions from the multi-component advertising campaign corresponding to the targeted web page; and the advertisement decision management computing system further configured to transmit instructions for inserting the multi-component advertisement identified in the selected campaign instruction into the plurality of advertising opportunities of the targeted web page.

In particular embodiments, the computerized system further comprises the advertisement decision management computing system further configured to define data representing a multi-component advertising campaign for a targeted video stream, the data specifying one or more campaign instructions, each of the campaign instructions identifying a multi-component advertisement and the targeted video stream, each advertising component of the multi-component advertisement corresponding to a respective one of the plurality of advertising opportunities in the targeted video stream; the advertisement decision management computing system further configured to receive an advertising request from the requesting device identifying the targeted video stream; the advertisement decision management computing system further configured to select one of the campaign instructions from the multi-component advertising campaign corresponding to the targeted video stream; and the advertisement decision management computing system further configured to transmit instructions for inserting the multi-component advertisement identified in the selected campaign instruction into the plurality of advertising opportunities of the targeted video stream.

In still particular embodiments, wherein each of the plurality of advertising opportunities is a time slot in the targeted video stream, the computerized system further comprises the advertisement decision management computing system further configured to receive a plurality of advertising requests from the requesting device during a presentation of the targeted video stream, each of the advertising requests identifying the targeted video stream and a time slot in the targeted video stream; the advertisement decision management computing system further configured to select one of the campaign instructions from the multi-component advertising campaign corresponding to the targeted video stream; and in response to each of the advertising requests, the advertisement decision management computing system further configured to transmit instructions for inserting one of the constituent advertising components of the multi-component advertisement identified in the selected campaign instruction according to the time slot identified in the advertising request.

Still another aspect of the claimed invention is a computer program product, tangibly embodied in a machine-readable storage device, for implementing a multi-component advertising campaign, comprising instructions being operable to cause data processing apparatus to define data representing a multi-component advertising campaign, the data specifying one or more campaign instructions, each of the campaign instructions identifying a multi-component advertisement and targeted digital media having a plurality of advertising opportunities, each advertising component of the multi-component advertisement corresponding to a respective one of the plurality of advertising opportunities; receive an advertising request from a requesting device during presentation of the targeted digital media; select one of the campaign instructions from the multi-component advertising campaign corresponding to the targeted digital media; and transmit information for inserting the multi-component advertisement identified in the selected campaign instruction into the plurality of advertising opportunities of the targeted digital media.

In particular embodiments, the computer program product further comprises instructions to define data representing a multi-component advertising campaign for a targeted web site, the data specifying one or more campaign instructions, each of the campaign instructions identifying a multi-component advertisement and a targeted web page of the web site, each advertising component of the multi-component advertisement corresponding to a respective one of the plurality of advertising opportunities in the targeted web page; receive an advertising request from the requesting device identifying the targeted web page; select one of the campaign instructions from the multi-component advertising campaign corresponding to the targeted web page; and transmit instructions for inserting the multi-component advertisement identified in the selected campaign instruction into the plurality of advertising opportunities of the targeted web page.

In particular embodiments, the computer program product further comprises instructions to define data representing a multi-component advertising campaign for a targeted video stream, the data specifying one or more campaign instructions, each of the campaign instructions identifying a multi-component advertisement and the targeted video stream, each advertising component of the multi-component advertisement corresponding to a respective one of the plurality of advertising opportunities in the targeted video stream; receive an advertising request from the requesting device identifying the targeted video stream; select one of the campaign instructions from the multi-component advertising campaign corresponding to the targeted video stream; and transmit instructions for inserting the multi-component advertisement identified in the selected campaign instruction into the plurality of advertising opportunities of the targeted video stream.

In still particular embodiments, wherein each of the plurality of advertising opportunities is a time slot in the targeted video stream, the computer program product further comprises instruction to receive a plurality of advertising requests from the requesting device during a presentation of the targeted video stream, each of the advertising requests identifying the targeted video stream and a time slot in the targeted video stream; select one of the campaign instructions from the multi-component advertising campaign corresponding to the targeted video stream; and in response to each of the advertising requests, transmit instructions for inserting one of the constituent advertising components of the multi-component advertisement identified in the selected campaign instruction according to the time slot identified in the advertising request.

In one or more of the various aspects of the claimed invention, the targeted video stream is a video-on-demand stream or a broadcast video stream; each of the campaign instructions defined in the multi-component advertising campaign specifies a different multi-component advertisement; and/or each of the campaign instructions defined in the multi-component advertising campaign specifies a different multi-component advertisement for a different client device type.

### BRIEF DESCRIPTION OF THE DRAWINGS

The foregoing and other objects, features and advantages of embodiments of the present invention will be apparent from the more particular description of preferred embodiments, as illustrated in the accompanying drawings in which like reference characters refer to the same elements throughout the different views. The drawings are not necessarily to scale, emphasis instead being placed upon illustrating the principles of the preferred embodiments.

FIGS. 1A and 1B are diagrams illustrating examples of multi-component advertising campaigns for various forms of digital media.

FIG. 2 is a diagram illustrating an architecture for implementing multi-component advertising campaigns, according to embodiments of the present invention.

FIG. 3 is a flow diagram that illustrates an exemplary method for implementing a multi-component advertising campaign, according to embodiments of the present invention.

FIG. 4 is a flow diagram that illustrates a method for defining a multi-component advertising campaign, according to embodiments of the present invention.

FIG. 5A is a flow diagram that illustrates a method for creating a multi-component advertisement, according to embodiments of the present invention.

FIG. 5B is a diagram illustrating an exemplary user interface 400 displaying templates for the multi-component advertisement.

FIG. 6 is a diagram illustrating services for implementing multi-component advertising campaigns, according to embodiments of the present invention.

FIG. 7 is a diagram illustrating an architecture for implementing an ad ingestion process, according to embodiments of the present invention.

### DETAILED DESCRIPTION

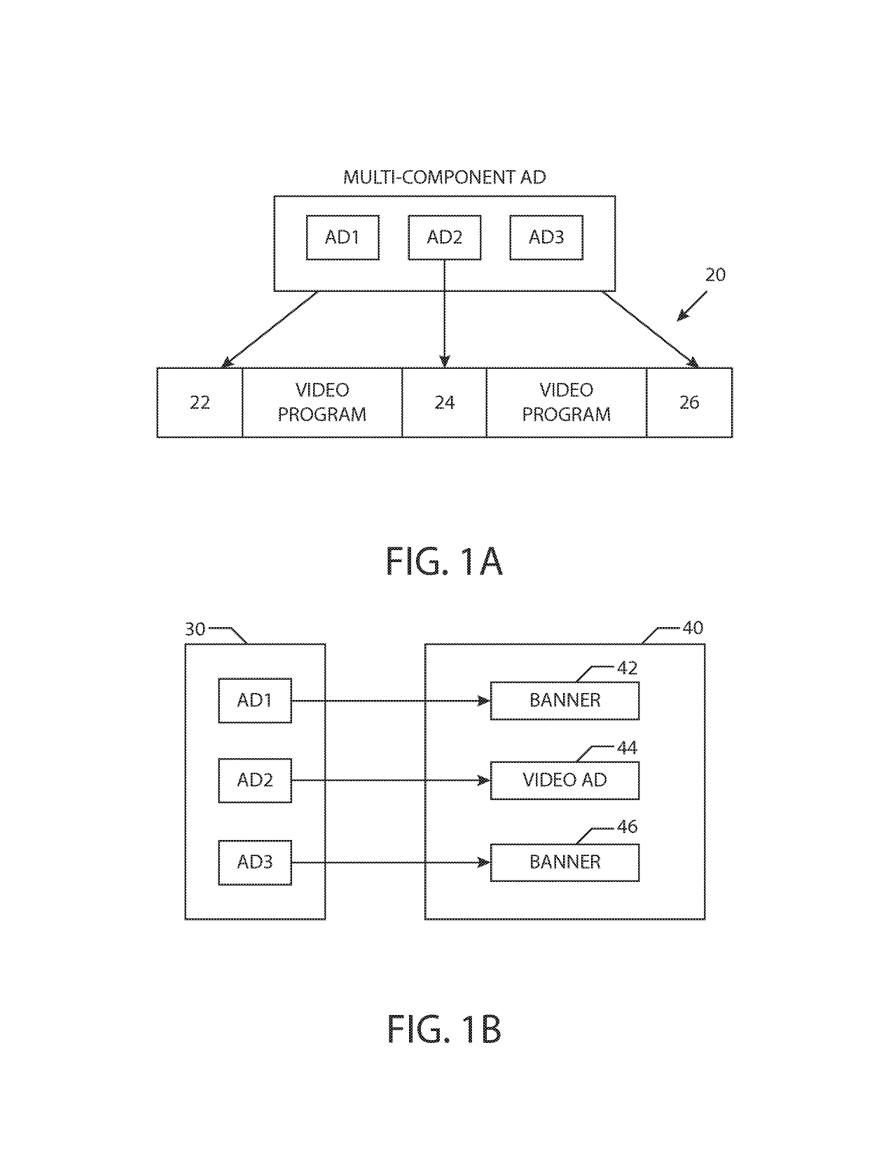

FIGS. 1A and 1B are diagrams illustrating examples of multi-component advertising campaigns for various forms of digital media. For example, FIG. 1A illustrates an example of a multi-component advertisement for a video stream, such as a video-on-demand stream or a broadcast video stream. As shown in FIG. 1A, the multi-component advertisement 10 includes multiple advertising components AD1, AD2, AD3 that are mapped to all of the advertising opportunities 22, 24, 26 (e.g., advertisement breaks, pre-rolls, post-rolls or overlays) in the targeted video stream 20.

FIG. 1B illustrates an example of multi-component advertisement for a web page. As shown in FIG. 1B, the multi-component advertisement 30 includes multiple advertising components AD1, AD2, AD3 mapped to all of the advertising opportunities 42, 44, 46 in a targeted web page 40. For example, advertising opportunities 42 and 46 are mapped to banner advertisements AD1 and AD3, while advertising opportunity 44 is mapped to video commercial AD2.

Preferably, the advertising components of the respective multi-component advertisement shown in FIGS. 1A and 1B are selected by, or on behalf of, an advertiser such that each of the selected advertising components are directed to a products or services of the advertiser. An advantage of defining multi-component advertising campaigns according to the claimed invention is to prevent presentation of competing advertising content at the same time (e.g., on the same web page) or same time intervals (e.g., during commercial breaks of the same video program).

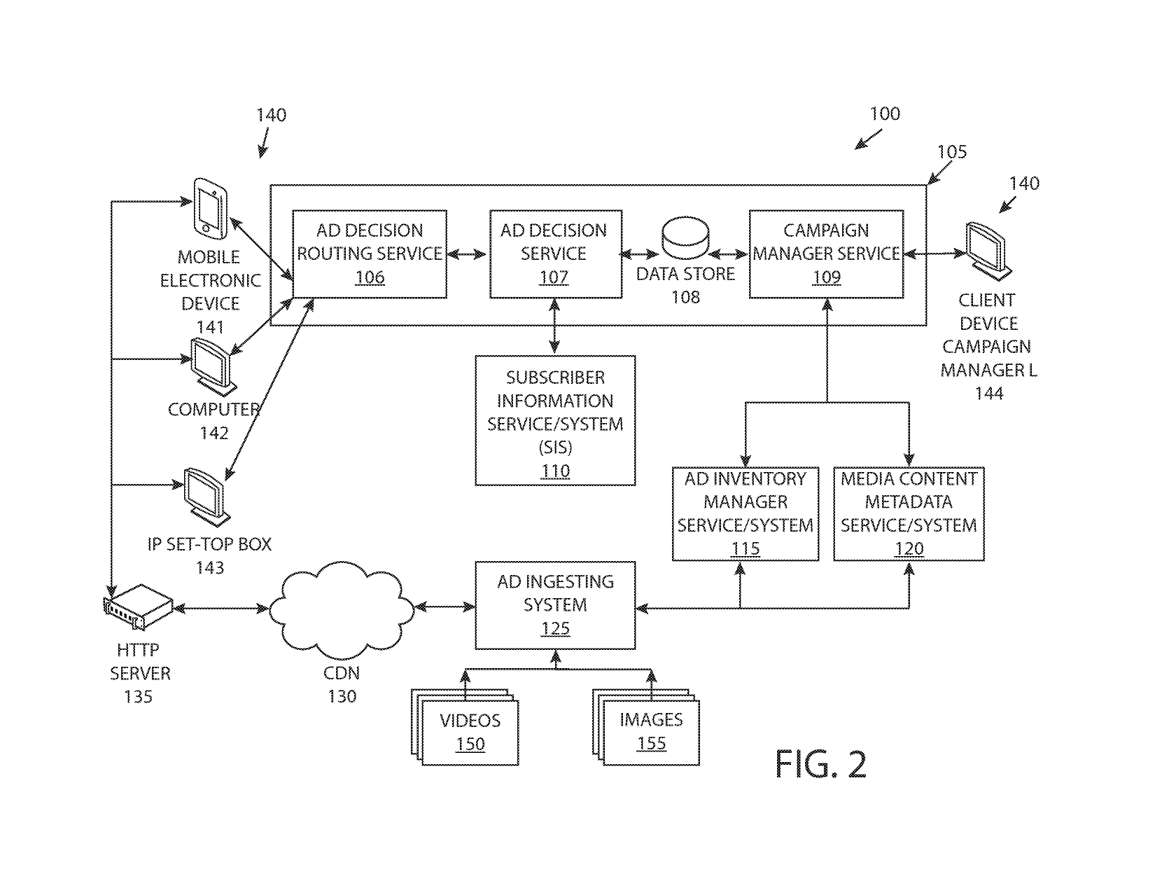

FIG. 2 is a diagram illustrating an architecture for implementing multi-component advertising campaigns, according to embodiments of the present invention. An architecture for implementing multi-component advertising campaigns 100 includes an ad decision management system 105, a subscriber information system 110, an ad inventory manager system 115, a media content metadata system 120, an ad ingesting system 125, a content distribution network 130, a web server 135 and clients 140.

Each of the ad decision management system 105, the subscriber information system 110, the ad inventory manager system 115, the media content metadata system 120, the ad ingesting system 125 and the web server 135 can be configured as separate or combined computing systems, such as, a computer system, a server system or a cluster of server systems. However, in other embodiments the ad decision management system 105, the subscriber information system 110, the ad inventory manager system 115, the media content metadata system 120, the ad ingesting system 125 and the web server 135 can be configured as one or more executable services for execution by a computer system, a server system or a cluster of server systems.

The ad decision management system 105 is configured to select and implement a multi-component advertising campaign based on one or more parameters or rules, and provide a plurality of advertising components to clients 140 requesting media content, such as, VOD content or web content. For example, the decision management system 105 can provide uniform resource locators (URLs) identifying the advertising components to the clients 140, which can retrieve media content associated with the advertising components from the web server 135. The URLs can be provided in a webpage file, such as an HTML file, or a VOD media stream file, such as a manifest file, or in a native Ad, such as a Flash or silverlight application. The ad decision management system 105 includes an ad decision routing service 106, an ad decision service 107, a data store 108 and a campaign manager service 109, which will be described in greater detail below.

The ad decision management system 105 is further configured to communicate with one or more of the clients 140, the subscriber information system 110, the ad inventory manager system 115 and the media content metadata system 120. For example, the ad management system 105 can communicate with the clients 140, the subscriber information system 110, the ad inventory manager system 115 and the media content metadata system 120 via private networks and/or the Internet.

The ad ingesting system 125 is configured to process and encode various types of advertising content, such as, video content 150, image content 155, audio content (not shown) and other types of digital advertising content. The ingested advertising content can be associated with an advertising component of a multi-component advertising campaign. The ad ingesting system 135 is configured to transfer the ingested advertising content to the content distribution network 130 for storing and hosting the content. However, in other embodiments the ad ingesting system 135 can store the advertising content locally. The ad ingesting system 135 operates in connection with the ad inventory manager system 115, which catalogs the ingested advertising content. In this manner, advertisers can search, lookup and select ingested advertising content for inclusion in multi-component advertising campaigns.

The web server 135 is configured to provide media content and/or advertising content to the clients 140. For example, the web server 135 can serve website content, VOD content and/or advertising media and content to the clients 140.

The methods and processes disclosed herein can be implemented by the above systems and devices, or equivalent systems and devices, executing a unique set of instructions stored or embodied in computer readable media. As will be appreciated by those skilled in the art, a unique set of instructions can be implemented or embodied as executable code, such as, software, firmware, machine code or a combination thereof. As such, the unique set of instructions stored or embodied in the computer readable media transforms the above systems and devices into particular, special purpose systems and devices that can operate, for example, according to the following exemplary flow diagrams. In some embodiments, unique sets of instructions correspond to the methods and processes disclosed in FIGS. 2-4 and described below in further detail.

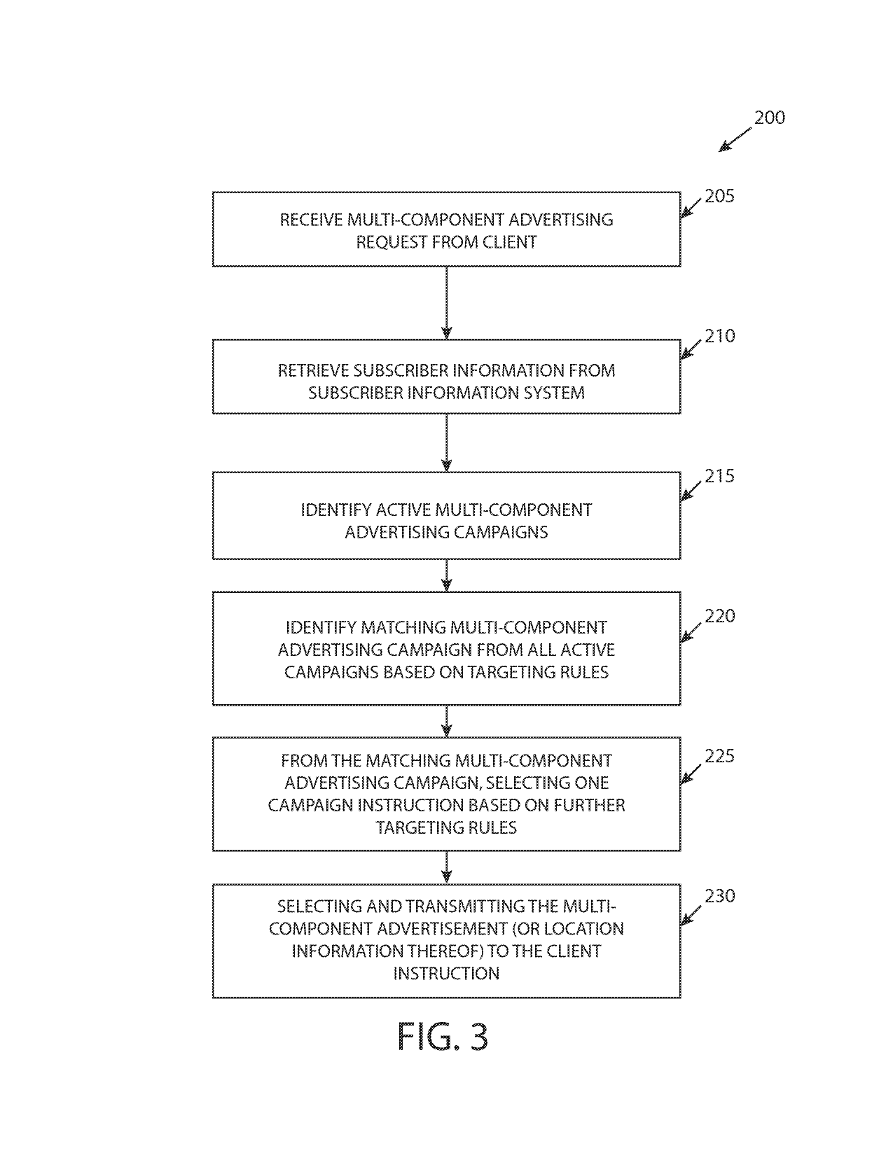

FIG. 3 is a flow diagram that illustrates an exemplary method (200) for implementing a multi-component advertising campaign, according to embodiments of the present invention.

Referring to FIGS. 2 and 3, the ad decision routing service 106 receives a multi-component advertising request from a client 140 (205). The clients 140 can include mobile electronic devices 141, such as mobile phones and tablet computers, computer systems 142, such as desktop computers, laptop computers and internet connected televisions, and IP set-top boxes 143. In other embodiments, the client can be a video splicer that inserts advertising content into broadcast video or VOD streams. The ad decision routing services 106 relays the ad requests to the ad decision service 107 for processing. The ad request can include information identifying the target digital media (e.g., video, web page, etc.). In the case of video streams, the ad request can also include time slot information for the advertising opportunity (e.g., pre-roll slot, post-roll slot, commercial break, for example).

Upon receiving the multi-component ad request, the ad decision service 107 can retrieve subscriber information from the subscriber information system 110 for the user or subscriber requesting media content (210). The subscriber information can include subscriber demographic data, subscriber geographic data or other subscriber accessible data. In the context of broadcast video, the subscriber information can also correspond to a regional population of subscribers. Such subscriber information can be used for comparison against the targeting rules defined in each multi-component advertising campaign.

The ad decision service 107 identifies active multi-component advertising campaigns (215). The ad decision service 107 can search or query the data store 108 for the data representing each of the multi-component advertising campaigns. The data store 108 is a repository of data, and can include various database systems. For example, as discussed in more detail below, multi-component advertising campaigns can be defined with activation rules for indicating when a respective campaign or specific campaign instruction thereof is active and available for selection. Examples of such activation rules can specify activation for a specific time frame and/or time of day.

From the identified active multi-component advertising campaign data, the ad decision service 107 identifies a matching multi-component advertising campaign that satisfies a set of targeting rules (220). For example, the targeting rules can compare the subscriber information retrieved at (210) against a desired set of attributes in order to target certain users, subscribers or groups of subscribers.

Once a matching multi-component advertising campaign is identified, the ad decision service 107 selects one of the campaign instructions defined therein based on further targeting rules. For example, different campaign instructions can depend on the device type of the client requesting the multi-component advertisement. Different campaign instructions can also depend on certain attributes, or metadata, of the target digital media. Such attributes can include the genre or rating for the contents of the target digital media. Different campaign instructions can also depend on one or more of the targeting rules, such as those discussed in (220).

Thereafter, the ad decision service 107 selects and transmits the multi-component advertisement (or location information thereof) to the client according to the selected campaign instruction (230). For example, where the targeted digital media is a web page, the entire set of advertising components that constitute the multi-component advertisement are transmitted. Conversely, where the targeted digital media is a video stream, it is possible that the constituent advertising components of the multi-component advertisement are transmitted one at a time. For example, as shown in FIG. 1A, the constituent components of a multi-component advertisement for the video stream can be transmitted individual in response to individual ad requests corresponding to the pre-roll, commercial break, and post-roll time slots.

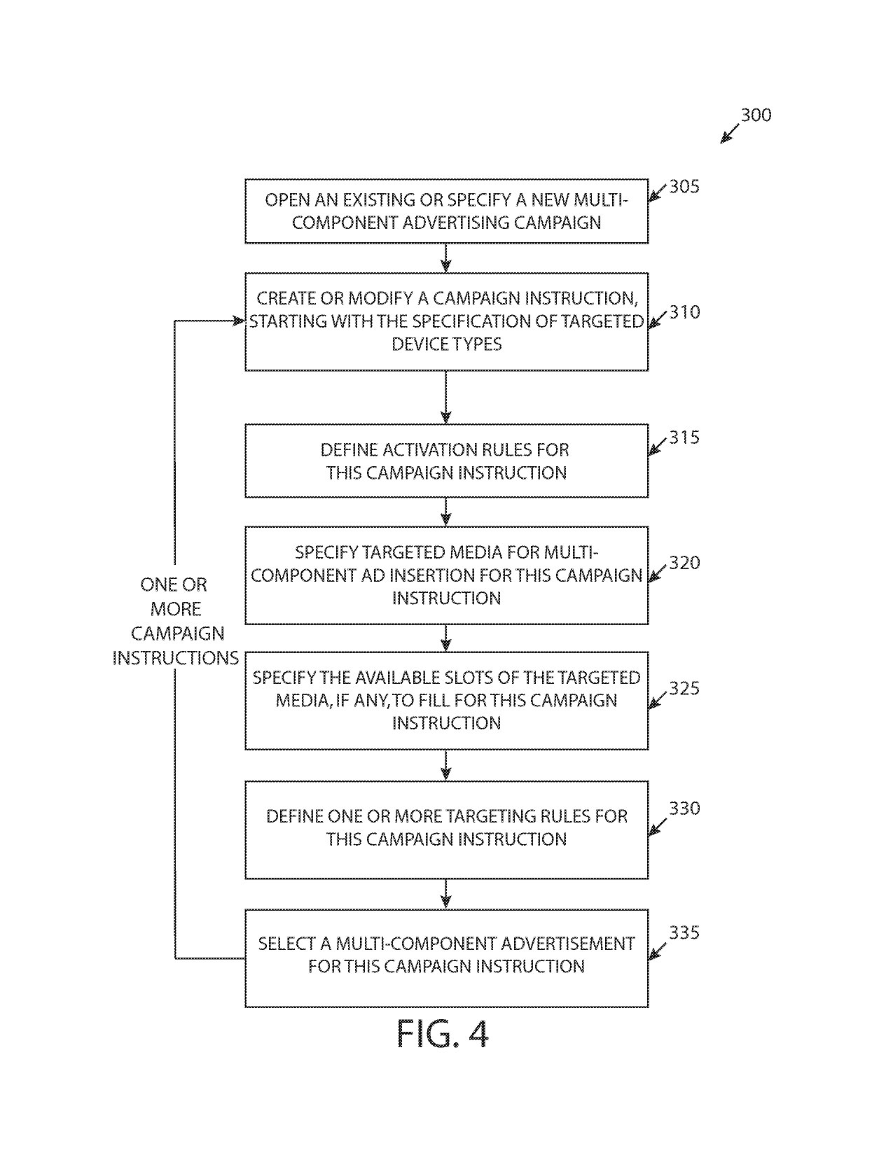

FIG. 4 is a flow diagram that illustrates a method for defining a multi-component advertising campaign, according to embodiments of the present invention. As described above, the systems and methods allow advertisers to create multi-component advertising campaigns that target all ad spots or placements (generally “advertising opportunities”) on a particular website or page of a website accessed by a given user and/or all ad spots or placements (generally “advertising opportunities”) within a particular media stream of a VOD service accessed a given user. The multi-component advertising campaigns can target users or audience members based on a defined set of rules. FIG. 4 illustrates an exemplary method (300) for defining a multi-component advertising campaign.

Referring to FIGS. 2 and 4, an advertiser or brand manager can open an existing, or specify a new, multi-component advertising campaign (305). The advertiser can access the campaign manager service 109 of the ad decision management system 105 via a user interface (UI). For example, the advertiser can access the UI of the campaign manager service 109 via a client 144.

Once accessed, the advertiser can create or modify a campaign instruction, starting with the specification of targeted client device types through the user interface (310). For example, the campaign instruction can be directed to mobile electronic devices 141, computer systems 142, and/or IP set-top boxes 143. In some embodiments, different campaign instructions can be defined for different client device types, including companion device types. For example, one campaign instruction can be defined for first screen device types (e.g., television, set-top box, PC computer), while another campaign instruction can be defined for second screen device types (e.g., smart phones and tablets). As a result, different campaign instructions, and thus different multi-component advertisements, can be applied according to the client device type.

Through the user interface of the campaign manager service 109, the advertiser can also define activation rules for determining when this campaign instruction is active and available for selection (315). Examples of such activation rules can specify activation for a specific time frame and/or time of day. The advertiser can also define activation rules relating to ad impression capping or other ad revenue model method rules.

Through the user interface of the campaign manager service 109, the advertiser also specifies the targeted digital media for this campaign instruction (320). For example, as shown in FIGS. 1A and 1B, the targeted digital media can be video stream (e.g., video-on-demand or broadcast video) or a web page. In the context of web site, different campaign instructions defined for the advertising campaign can correspond to different web pages. Furthermore, where the target digital media is a video stream, for example, the advertiser can also specify the available time slots (e.g., pre-roll, commercial break, and post-roll time slots) that are each populated by at least one constituent advertising component of the multi-component advertisement in this campaign instruction (325).

Through the user interface of the campaign manager service 109, the advertiser can also specify one or more targeting rules for selecting this campaign instruction (330). For example, the targeting rules can specify attributes or profiles to target certain users, subscribers or groups of subscribers. Further targeting rules can target digital media having certain attributes, such as genre or rating of the target digital media contents. The media content metadata service/system 120 can provide searchable content metadata to the campaign manager service 109 for selection by an advertiser.

Through the user interface of the campaign manager service 109, the advertiser can specify a multi-component advertisement for this campaign instruction (335), such as the exemplary multi-component advertisement described in FIGS. 1A and 1B. In the case where the target digital media is a video stream having advertising opportunities at specific time slots, the multi-component advertisement preferably includes information specifying the time slot in which each of the constituent advertising components is to be inserted.

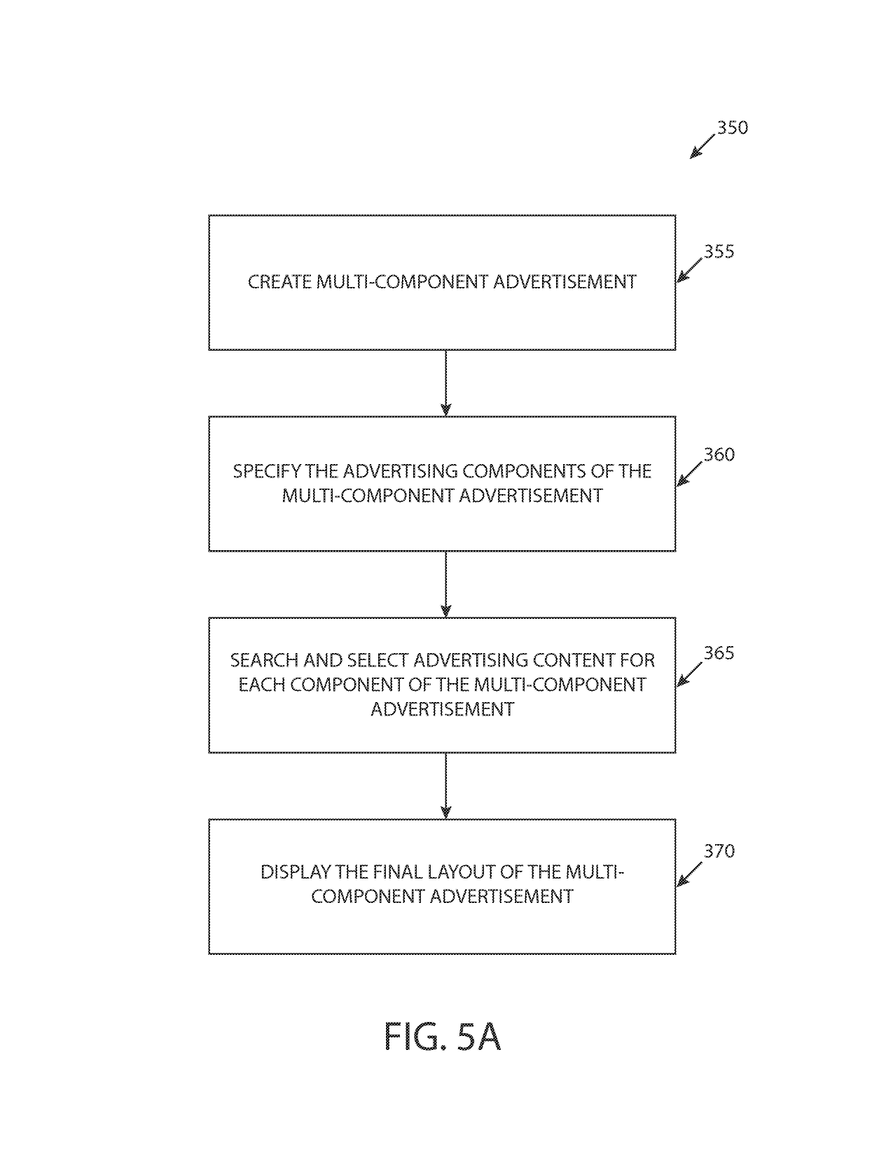

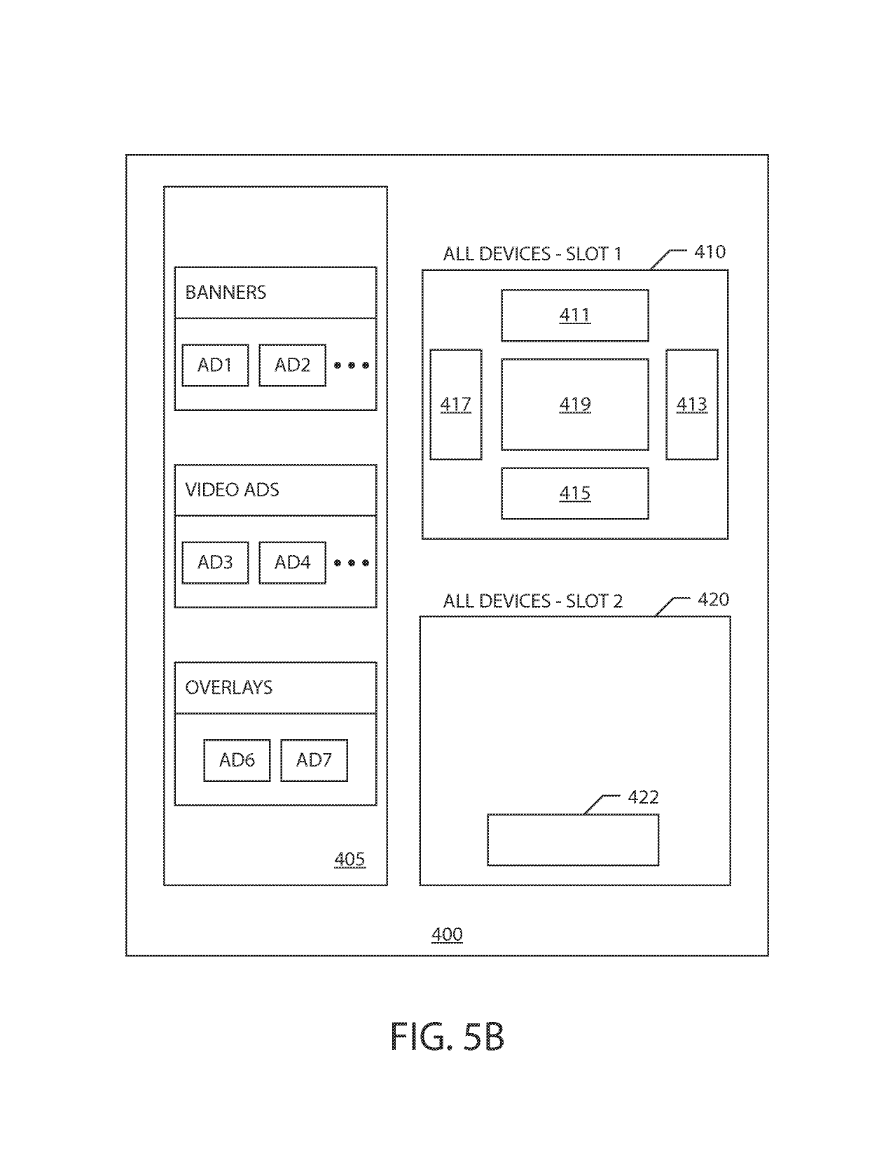

FIG. 5A is a flow diagram that illustrates a method for creating a multi-component advertisement, according to embodiments of the present invention. As described above in FIG. 4, advertisers can select multi-component advertisement for insertion into targeted digital media when defining a multi-component advertising campaign. FIG. 5A illustrates an exemplary method (350) for creating a multi-component advertisement that can be selected when defining a multi-component advertising campaign.

After accessing the user interface of the campaign manager server 109, a user can create a multi-component advertisement through a user interface (355). The multi-component advertisement can be created from a template that includes a predetermined layout of the individual advertising components. Alternatively, the user can customize the layout of the individual advertising components through the user interface, specifying the desired component types (e.g., banner, video, overlay, native Ads, dynamic HTML pages, etc) (360).

FIG. 5B is a diagram illustrating an exemplary user interface 400 displaying templates for the multi-component advertisement 410, 420. Specifically, template 410 can be used to define a multi-component advertisement for a web page having advertising components 411, 413, 415, 417 and 419. In this example, the advertising components 411, 413, 415, 417 correspond to banners and advertising component 419 corresponds to a commercial video. Template 420 can be used to define an advertising component of a multi-component advertisement for insertion into a video stream. In this example, the advertising component is an overlay 422 having a defined display period.

Through the user interface, the advertiser can also search for and select the advertising content to populate the individual advertising components of the multi-component advertisement (365). For example, in FIG. 5B, the user can perform a drag-and-drop operation on the advertising content 405 displayed in the form of images, videos, HTML pages and native Ads onto the respective advertising components (e.g., banners, overlays, video spots, etc) in the template. The advertising content can be obtained from an Ad Inventory Management service/system 115, for example. After the layout of the multi-component advertisement is complete, the campaign manager service 109 can display the final layout to the user/advertiser for confirmation (370).

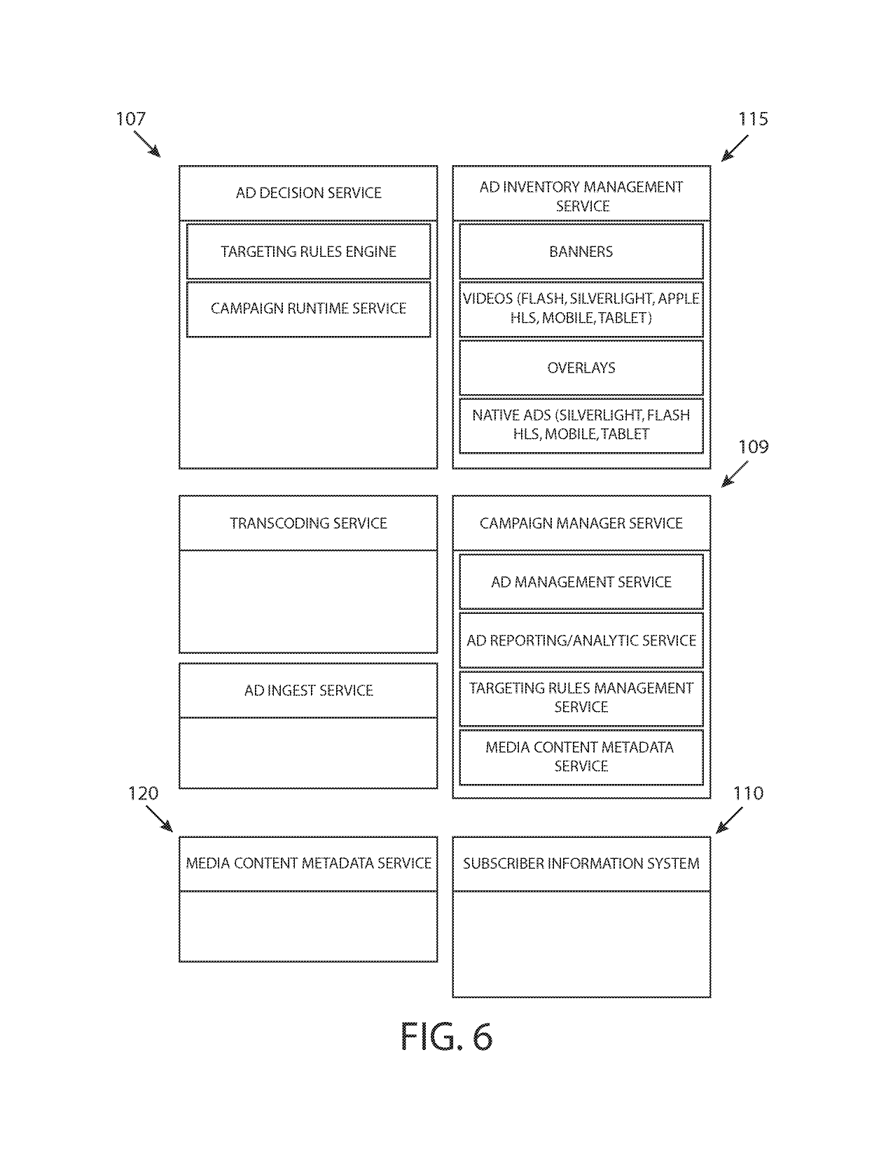

FIG. 6 is a diagram illustrating services for implementing multi-component advertising campaigns, according to embodiments of the present invention. The ad decision routing service 106 and the ad decision service 107 can include a targeting rules engine and a campaign runtime service. The targeting rules engine is configured to execute and match targeting rules with subscriber information and a metadata of the targeted digital media. For example, the targeting rules engine can determine whenever a requesting subscriber's information matches a set of targeting rules. The campaign runtime service is configured to interface with the subscriber information system 110 to retrieve subscriber information. The campaign runtime service is also configured to interface with the ad campaign management service 109 to retrieve active campaigns based on subscriber information and the metadata of the targeted digital media. The campaign runtime service is also configured to pass targeting rules to the targeting rules engine, and construct and return an ad decision from matching targeting rules. For example, when the runtime service receives a request for a particular subscriber “S1” and media file “M1”, the runtime service will interface with the ad campaign management service 109 to retrieve active ad campaigns targeting the media file “M1”. The runtime service will then interface with the subscriber information system 110 to retrieve user attributes for the subscriber “S1”, and pass the targeting rules from the active campaigns and the attributes of subscriber “S1” to the targeting rules engine. The runtime service can construct an ad decision based on the result returned from the targeting rules engine.

The ad inventory management service 115 includes a catalog of ingested advertising content, such as, banner content, video content, overlay content and native ad content.

The ad campaign management service 109 includes an ad management service, an ad reporting/analytic service, a targeting rules management service and a media content metadata service. The ad campaign management service is configured to allow advertisers to create and modify multi-component advertising campaigns. The ad reporting/analytic service is configured to provide advertising reporting information of multi-component advertising campaigns. The targeting rules management service is configured to allow users to create and modify targeting rules and parameters for each multi-component advertising campaign. The media content metadata service provides advertisers with searchable metadata of media content accessed by users or audience members.

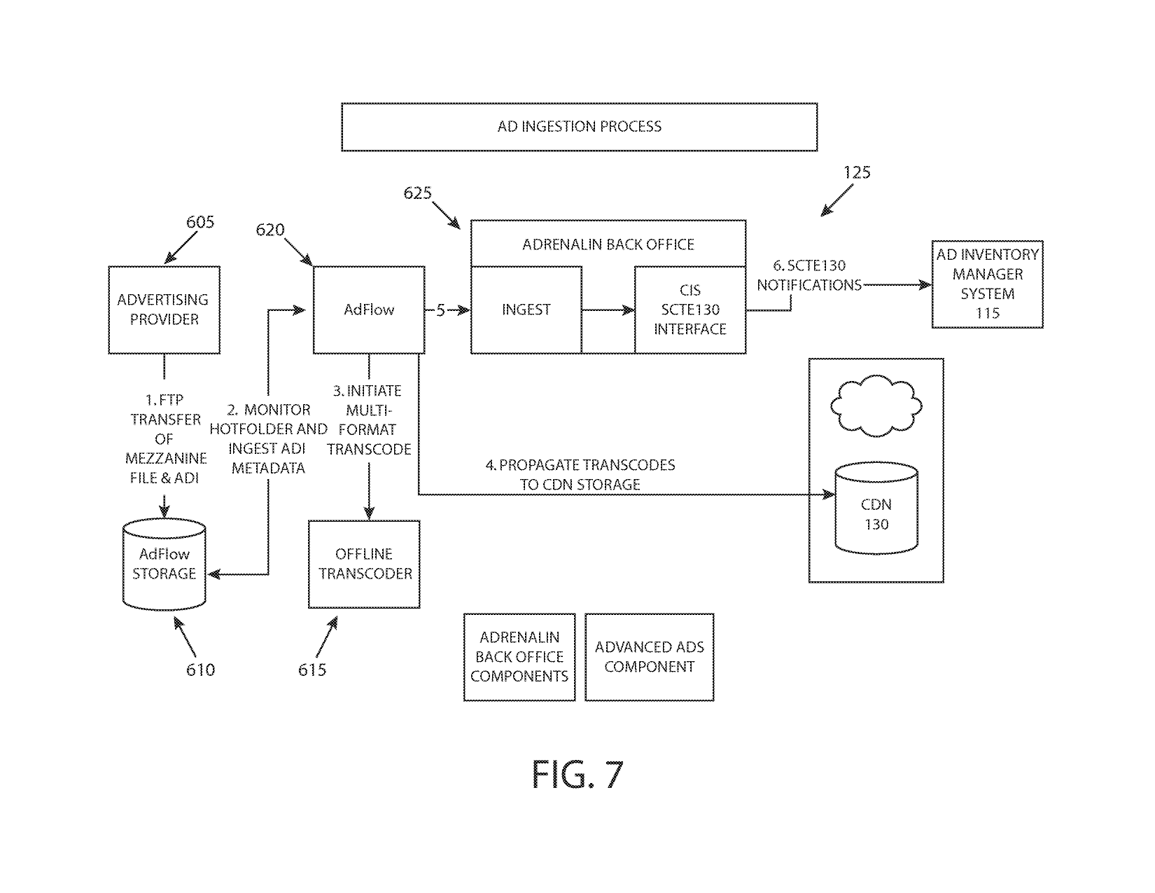

FIG. 7 is a diagram illustrating an architecture for implementing an ad ingestion process, according to embodiments of the present invention. As described above, the ad ingesting system 125 is configured to process various types of advertising content, such as, video content, image content, audio content and other types of digital advertising content.

An advertising provider 605 can submit advertising content to the ad ingesting system 125, for example, via the FTP transport protocol. However, the advertising provider 605 can submit advertising content via other known transport protocols or methods. The advertising content can be stored in the ad flow storage system 610 before processing of the advertising content begins.

The ad ingesting system 125 can be configured to monitor advertising content submissions, and initiate a multi-format transcoding process at an offline transcoder 615. After transcoding, an adflow processing system 620 transfers transcoded advertising content to the content distribution network 130, which stores and hosts the transcoded advertising content.

The adrenalin system 625 ingests the advertising content metadata and notifies the ad inventory management system of newly available advertisements through the SCTE 130 protocol.

Without limiting the foregoing, the techniques described above can be implemented in digital electronic circuitry or in computer hardware that executes firmware, software, or combinations thereof, for example. The implementation can be as a computer program product, e.g., a computer program tangibly embodied in a machine-readable storage device, for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network.

Machine-readable storage devices suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The terms “module” and “function,” as used herein, mean, but are not limited to, a hardware component or a combined software and hardware component which performs certain tasks. A module may advantageously be configured to reside on addressable storage device and configured to execute on one or more processors. A module may be fully or partially implemented with a general purpose integrated circuit (IC), FPGA, or ASIC. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

While the present inventive concepts have been particularly shown and described above with reference to exemplary embodiments thereof, it will be understood by those of ordinary skill in the art, that various changes in form and detail can be made without departing from the spirit and scope of the present inventive concepts described and defined by the following claims.

What is claimed is:

1. A computerized method for implementing a multi-component advertising campaign, comprising:
defining data representing a multi-component advertising campaign, the data specifying one or more campaign instructions, each of the campaign instructions identifying a multi-component advertisement and targeted digital media having a plurality of advertising opportunities, each advertising component of the multi-component advertisement corresponding to a respective one of the plurality of advertising opportunities;
receiving an advertising request from a requesting device during presentation of the targeted digital media;
selecting one of the campaign instructions from the multi-component advertising campaign corresponding to the targeted digital media; and
transmitting information for inserting the multi-component advertisement identified in the selected campaign instruction into the plurality of advertising opportunities of the targeted digital media.

2. The computerized method of claim 1 further comprising:
defining data representing a multi-component advertising campaign for a targeted web site, the data specifying one or more campaign instructions, each of the campaign instructions identifying a multi-component advertisement and a targeted web page of the web site, each advertising component of the multi-component advertisement corresponding to a respective one of the plurality of advertising opportunities in the targeted web page;
receiving an advertising request from the requesting device identifying the targeted web page;
selecting one of the campaign instructions from the multi-component advertising campaign corresponding to the targeted web page; and
transmitting instructions for inserting the multi-component advertisement identified in the selected campaign instruction into the plurality of advertising opportunities of the targeted web page.

3. The computerized method of claim 1 further comprising:
defining data representing a multi-component advertising campaign for a targeted video stream, the data specifying one or more campaign instructions, each of the campaign instructions identifying a multi-component advertisement and the targeted video stream, each advertising component of the multi-component advertisement corresponding to a respective one of the plurality of advertising opportunities in the targeted video stream;
receiving an advertising request from the requesting device identifying the targeted video stream;
selecting one of the campaign instructions from the multi-component advertising campaign corresponding to the targeted video stream; and
transmitting instructions for inserting the multi-component advertisement identified in the selected campaign instruction into the plurality of advertising opportunities of the targeted video stream.

4. The computerized method of claim 3 wherein each of the plurality of advertising opportunities is a time slot in the targeted video stream,
receiving a plurality of advertising requests from the requesting device during a presentation of the targeted video stream, each of the advertising requests identifying the targeted video stream and a time slot in the targeted video stream;
selecting one of the campaign instructions from the multi-component advertising campaign corresponding to the targeted video stream; and
in response to each of the advertising requests, transmitting instructions for inserting one of the constituent advertising components of the multi-component advertisement identified in the selected campaign instruction according to the time slot identified in the advertising request.

5. The method of claim 3 wherein the targeted video stream is a video-on-demand stream or a broadcast video stream.

6. The computerized method of claim 1 wherein each of the campaign instructions defined in the multi-component advertising campaign specifies a different multi-component advertisement.

7. The computerized method of claim 1 wherein each of the campaign instructions defined in the multi-component advertising campaign specifies a different multi-component advertisement for a different client device type.

8. A computerized system for implementing a multi-component advertising campaign, comprising:
an advertisement decision management computing system configured to define data representing a multi-component advertising campaign, the data specifying one or more campaign instructions, each of the campaign instructions identifying a multi-component advertisement and targeted digital media having a plurality of advertising opportunities, each advertising component of the multi-component advertisement corresponding to a respective one of the plurality of advertising opportunities;
the advertisement decision management computing system further configured to receive an advertising request from a requesting device during presentation of the targeted digital media;
the advertisement decision management computing system further configured to select one of the campaign instructions from the multi-component advertising campaign corresponding to the targeted digital media; and
the advertisement decision management computing system further configured to transmit information for inserting the multi-component advertisement identified in the selected campaign instruction into the plurality of advertising opportunities of the targeted digital media.

9. The computerized system of claim 8 further comprising:
the advertisement decision management computing system further configured to define data representing a multi-component advertising campaign for a targeted web site, the data specifying one or more campaign instructions, each of the campaign instructions identifying a multi-component advertisement and a targeted web page of the web site, each advertising component of the multi-component advertisement corresponding to a respective one of the plurality of advertising opportunities in the targeted web page;
the advertisement decision management computing system further configured to receive an advertising request from the requesting device identifying the targeted web page;
the advertisement decision management computing system further configured to select one of the campaign instructions from the multi-component advertising campaign corresponding to the targeted web page; and
the advertisement decision management computing system further configured to transmit instructions for inserting the multi-component advertisement identified in the selected campaign instruction into the plurality of advertising opportunities of the targeted web page.

10. The computerized system of claim 8 further comprising:
the advertisement decision management computing system further configured to define data representing a multi-component advertising campaign for a targeted video stream, the data specifying one or more campaign instructions, each of the campaign instructions identifying a multi-component advertisement and the targeted video stream, each advertising component of the multi-component advertisement corresponding to a respective one of the plurality of advertising opportunities in the targeted video stream;
the advertisement decision management computing system further configured to receive an advertising request from the requesting device identifying the targeted video stream;
the advertisement decision management computing system further configured to select one of the campaign instructions from the multi-component advertising campaign corresponding to the targeted video stream; and
the advertisement decision management computing system further configured to transmit instructions for inserting the multi-component advertisement identified in the selected campaign instruction into the plurality of advertising opportunities of the targeted video stream.

11. The computerized system of claim 10 wherein each of the plurality of advertising opportunities is a time slot in the targeted video stream,
the advertisement decision management computing system further configured to receive a plurality of advertising requests from the requesting device during a presentation of the targeted video stream, each of the advertising requests identifying the targeted video stream and a time slot in the targeted video stream;
the advertisement decision management computing system further configured to select one of the campaign instructions from the multi-component advertising campaign corresponding to the targeted video stream; and
in response to each of the advertising requests, the advertisement decision management computing system further configured to transmit instructions for inserting one of the constituent advertising components of the multi-component advertisement identified in the selected campaign instruction according to the time slot identified in the advertising request.

12. A computer program product, tangibly embodied in a machine-readable storage device, for implementing a multi-component advertising campaign, comprising instructions being operable to cause data processing apparatus to:
define data representing a multi-component advertising campaign, the data specifying one or more campaign instructions, each of the campaign instructions identifying a multi-component advertisement and targeted digital media having a plurality of advertising opportunities, each advertising component of the multi-component advertisement corresponding to a respective one of the plurality of advertising opportunities;
receive an advertising request from a requesting device during presentation of the targeted digital media;
select one of the campaign instructions from the multi-component advertising campaign corresponding to the targeted digital media; and
transmit information for inserting the multi-component advertisement identified in the selected campaign instruction into the plurality of advertising opportunities of the targeted digital media.

13. The computer program product of claim 12 further comprising instructions to:
define data representing a multi-component advertising campaign for a targeted web site, the data specifying one or more campaign instructions, each of the campaign instructions identifying a multi-component advertisement and a targeted web page of the web site, each advertising component of the multi-component advertisement corresponding to a respective one of the plurality of advertising opportunities in the targeted web page;
receive an advertising request from the requesting device identifying the targeted web page;
select one of the campaign instructions from the multi-component advertising campaign corresponding to the targeted web page; and
transmit instructions for inserting the multi-component advertisement identified in the selected campaign instruction into the plurality of advertising opportunities of the targeted web page.

14. The computer program product of claim 12 further comprising instructions to:
define data representing a multi-component advertising campaign for a targeted video stream, the data specifying one or more campaign instructions, each of the campaign instructions identifying a multi-component advertisement and the targeted video stream, each advertising component of the multi-component advertisement corresponding to a respective one of the plurality of advertising opportunities in the targeted video stream;
receive an advertising request from the requesting device identifying the targeted video stream;
select one of the campaign instructions from the multi-component advertising campaign corresponding to the targeted video stream; and
transmit instructions for inserting the multi-component advertisement identified in the selected campaign instruction into the plurality of advertising opportunities of the targeted video stream.

15. The computer program product of claim 14 wherein each of the plurality of advertising opportunities is a time slot in the targeted video stream, the computer program product further comprising instruction to:
receive a plurality of advertising requests from the requesting device during a presentation of the targeted video stream, each of the advertising requests identifying the targeted video stream and a time slot in the targeted video stream;
select one of the campaign instructions from the multi-component advertising campaign corresponding to the targeted video stream; and
in response to each of the advertising requests, transmit instructions for inserting one of the constituent advertising components of the multi-component advertisement identified in the selected campaign instruction according to the time slot identified in the advertising request.
